(19) United States
(12) Patent Application Publication
(10) Pub. No.: US 2011/0259258 A1
(43) Pub. Date: Oct. 27, 2011

(54) HEAVY EQUIPMENT SAFETY DEVICES AND SYSTEMS, AND METHODS THEREOF

(76) Inventor: Mark A. DePiero, Newburyport, MA (US)

(21) Appl. No.: 13/092,536

(22) Filed: Apr. 22, 2011

Related U.S. Application Data
(60) Provisional application No. 61/327,232, filed on Apr. 23, 2010.

(51) Int. Cl. G01D 13/00

(52) U.S. Cl. 116/200

(57) ABSTRACT

A safety device includes an elongated wand having an enlarged impact head. The elongated wand is flexible in vertical and horizontal directions with respect to a lengthwise direction of extension of the elongated wand.

### RELATED APPLICATIONS

This application claims the benefit of U.S. Provisional Application No. 61/327,232, filed Apr. 23, 2010, the contents of which are incorporated herein by reference in their entirety.

### TECHNICAL FIELD

The present inventive concepts relate generally to safety devices, systems and methods, and more particularly, to safety devices, systems and methods for heavy equipment.

### BACKGROUND

Heavy equipment operators are relied upon to safely operate, control and maneuver heavy equipment, such as skid steers, excavators, telehandlers and the like. However, many workers each year are crushed, struck or run over by heavy equipment. Further, workers can be pinned between equipment surfaces and buildings or other objects by maneuvering equipment or parts thereof. As a result, workers can suffer debilitating injuries which can prevent them from returning to work or even death. These accidents are often due to noisy work site conditions, limited operator visibility and/or distractions to operators and nearby workers.

To combat the growing trend of work site accidents, organizations such as the U.S. Occupational Safety and Health Administration (OSHA) suggest that workers be trained to stay clear of moving equipment. OSHA has further suggested the deployment of an optional spotter to help guide an equipment operator. Despite these suggestions, construction workers may need to work in close vicinity with heavy equipment, thus increasing the likelihood of an accident. Further, due to cost constraints, it may not be feasible to employ a dedicated spotter to help guide an equipment operator. Further, even if a spotter is deployed, the spotter can be distracted by other job responsibilities and momentary distractions.

### SUMMARY

Embodiments of the present inventive concepts are directed to safety devices and systems, and methods of manufacturing, installing, and using such safety devices and systems that further address and reduce work site accidents associated with heavy equipment, vehicles or other types of movable and non-movable equipment. In particular, some embodiments provide passive and active safety devices, systems and methods that realize, among other features, the ability for workers in a zone of danger to be physically notified of impending danger, and that further provide capabilities for sensing workers and/or objects that are in a zone of danger and in response thereto, activating a response avoidance procedure. Embodiments are applicable to both non-stationary and stationary heavy equipment, as well as other types of equipment and vehicles.

In one aspect, a safety device system comprises at least one wand having an enlarged impact head, wherein the at last one wand is flexible in vertical and horizontal directions with respect a lengthwise direction of extension of the at least one wand.

In some embodiments, the at least one wand is attached to a rear surface of a heavy equipment vehicle.

In some embodiments, the at least one wand is attached to a side surface of a heavy equipment vehicle.

In another aspect, a heavy equipment safety device comprises a base fixedly attachable to a heavy equipment machine; and at least one elongated wand removably attachable to the base, the elongated wand comprising a flexible material, and wherein the elongated wand is flexible in horizontal and vertical directions of movement with respect to the base member.

In some embodiments, at least one of the attachment mechanisms is a pressure-fit socket having a breakaway force of about 5 pounds to about 15 pounds.

In some embodiments, at least one of the attachment mechanisms is a quick-release mechanism.

In some embodiments, the at least one elongated wand comprises concentric telescoping segments.

In some embodiments, the flexible material comprises a material selected from the group consisting of spring steel, coiled metal and plastic.

In some embodiments, the elongated wand is at least 3 feet in length.

In some embodiments, the heavy equipment safety device is attached to a heavy equipment machine weighing at least 5 tons in gross weight.

In some embodiments, the heavy equipment safety device is attached to a heavy equipment machine weighing at least 10 tons in gross weight.

In some embodiments, the heavy equipment safety device is attached to a heavy equipment machine weighing at least 15 tons in gross weight.

In some embodiments, the heavy equipment safety device is attached to a heavy equipment machine weighing at least 20 tons in gross weight.

In some embodiments, the heavy equipment safety device is attached to a heavy equipment machine weighing at least 25 tons in gross weight.

In another aspect, a safety device, comprises: an elongated wand having an enlarged impact head, wherein the elongated wand is flexible in vertical and horizontal directions with respect to a lengthwise direction of extension of the elongated wand.

In some embodiments, the enlarged impact head is provided at a distal end of the elongated wand.

In some embodiments, a thickness of the enlarged impact head is greater than a thickness of a proximal end of the elongated wand.

In some embodiments, a thickness of the enlarged impact head is greater than a thickness of a central portion of the elongated wand.

In some embodiments, the enlarged impact head is integral with the elongated wand.

In some embodiments, the elongated wand is tapered.

In some embodiments, the enlarged impact head is coupled to a distal end of the elongated wand.

In some embodiments, the enlarged impact head is removably coupled to the distal end of the elongated wand.

In some embodiments, a cross-section of the elongated wand in a direction perpendicular to the lengthwise direction of extension is circular.

In some embodiments, a cross-section of the elongated wand in a direction perpendicular to the lengthwise direction of extension is elliptical.

In some embodiments, a cross-section of the elongated wand in a direction perpendicular to the lengthwise direction of extension is rectangular.

In some embodiments, the elongated wand has an increased flexibility in the vertical direction with respect to a flexibility of the elongated wand in the horizontal direction.

In some embodiments, the elongated wand has an increased flexibility in the horizontal direction with respect to a flexibility of the elongated wand in the vertical direction.

In some embodiments, the elongated wand is flexible in the lengthwise direction of extension.

In some embodiments, comprising an attachment mechanism, wherein the attachment mechanism is constructed and arranged to secure the elongated wand to a piece of heavy equipment.

In some embodiments, the attachment mechanism is selected from the group consisting of: a male connector, a female connector, a pressure fit socket, a breakaway connector and a bracket.

In some embodiments, the attachment mechanism is constructed and arranged to allow the elongated wand to separate from the attachment mechanism at or above a predetermined amount of pressure.

In some embodiments, the elongated wand is at least 3 feet in length.

In some embodiments, the enlarged impact head includes a material selected from the group consisting of: rubber, plastic and foam.

In some embodiments, the elongated wand includes a material selected from the group consisting of: plastic, fiberglass, graphite and steel.

In some embodiments, the elongated wand is constructed and arranged to flex at least ±20 degrees in the vertical direction.

In some embodiments, the elongated wand is constructed and arranged to flex at least ±20 degrees in the horizontal direction.

In another aspect, a safety system, comprises: an elongated wand having an enlarged impact head; a sensor coupled to the elongated wand; and a processing system configured to affect operational characteristics of a piece of heavy equipment in response to a signal generated by the sensor.

In some embodiments, the sensor is constructed and arranged to detect a bystander or object near an equipments zone of danger.

In some embodiments, when the sensor detects the bystander or object near the equipment's zone of danger the sensor generates the signal.

In some embodiments, the sensor is constructed and arranged to detect a bystander or object within an equipments zone of danger.

In some embodiments, when the sensor detects the bystander or object within the equipment's zone of danger the sensor generates the signal.

In some embodiments, the sensor includes one selected from the group consisting of: a pressure sensor, a capacitance sensor, a heat sensor, an infrared sensor and a switch.

In some embodiments, the sensor is provided at a distal end of the elongated wand.

In some embodiments, the sensor is provided at a proximal end of the elongated wand.

In some embodiments, the processing system is further configured to disable the piece of heavy equipment in response to the signal generated by the sensor.

In some embodiments, the processing system is further configured to halt the piece of heavy equipment in response to the signal generated by the sensor.

In some embodiments, the processing system is further configured to bring the piece of heavy equipment to a controlled stop in response to the signal generated by the sensor.

In another aspect, a method of operating a piece of heavy equipment, comprises: enabling a piece of heavy equipment; detecting a bystander or object near the piece of heavy equipment's zone of danger; and affecting operational characteristics of the piece of heavy equipment in response to the detecting of a bystander or object near the piece of heavy equipment's zone of danger.

In some embodiments, affecting the operational characteristics of the piece of heavy equipment in response to the detecting of a bystander or object near the piece of heavy equipment's zone of danger includes disabling the piece of heavy equipment.

In some embodiments, affecting the operational characteristics of the piece of heavy equipment in response to the detecting of a bystander or object near the piece of heavy equipment's zone of danger includes halting the piece of heavy equipment.

In some embodiments, affecting the operational characteristics of the piece of heavy equipment in response to the detecting of a bystander or object near the piece of heavy equipment's zone of danger includes initiating a controlled stop of the piece of heavy equipment. In some embodiments, the method further comprises: providing an elongated wand having an enlarged impact head, wherein the elongated wand is coupled to the piece of heavy equipment; providing a sensor coupled to the elongated wand; and providing a processing system for affecting the operational characteristics of the piece of heavy equipment.

In another aspect, a method of passively alerting bystanders to an equipment's zone of danger, comprises: providing at least one elongated wand coupled to a piece of heavy equipment; and visually notifying a bystander to an equipment's zone of danger.

In some embodiments, the method further comprises physically notifying a bystander to an equipment's zone of danger.

### BRIEF DESCRIPTION OF THE DRAWINGS

The foregoing and other objects, features and advantages of embodiments of the invention will be apparent from the more particular description of preferred embodiments, as illustrated in the accompanying drawings in which like reference characters refer to the same parts throughout the different views. The drawings are not necessarily to scale, emphasis instead being placed upon illustrating the principles of the preferred embodiments.

FIG. 1A is a three-dimensional perspective view of a safety device in accordance with embodiments of the present specification.

FIG. 1B is a cross-sectional view of a wand of a safety device in accordance with embodiments of the present specification.

FIG. 1C is a cross-sectional view of a wand of a safety device in accordance with another embodiment of the present specification.

FIG. 2A is a side view of a safety device attached to equipment in accordance with embodiments of the present specification.

FIG. 2B is a side view of a safety device attached to equipment in accordance with embodiments of the present specification.

FIG. 2C is a three-dimensional perspective view of a safety device in accordance with another embodiment of the present specification.

FIG. 2D is a three-dimensional perspective view of a safety device in accordance with another embodiment of the present specification.

FIG. 2E is a front view of a base in accordance with embodiments of the present specification.

FIG. 2F is a front view of a base in accordance with another embodiment of the present specification.

FIG. 2G is a side view of an articulating base in accordance with embodiments of the present specification.

FIG. 3A is a side and rear perspective view of a skid steer having a safety device attached thereto in accordance with embodiments of the present specification.

FIG. 3B is a top view of the skid steer shown in FIG. 3A in accordance with embodiments of the present specification.

FIG. 4A is a side and rear perspective view of an excavator having a safety device attached thereto in accordance with embodiments of the present specification; FIG. 4B is a top view of the excavator shown in FIG. 4A in accordance with embodiments of the present specification; and FIG. 4C is a side view of the excavator shown in FIG. 4A in accordance with embodiments of the present specification.

FIG. 5A is a side and rear perspective view of a telehandler having a safety device attached thereto in accordance with embodiments of the present specification; FIG. 5B is a side view of the telehandler shown in FIG. 5A in accordance with embodiments of the present specification; and FIG. 5C is a top view of the telehandler shown in FIG. 5A in accordance with embodiments of the present specification.

FIG. 6 is a block diagram of a safety device system in accordance with embodiments of the present specification.

FIG. 7 is a block diagram of an I/O subsystem having sensors connected thereto in accordance with embodiments of the present specification.

FIG. 8 is a flow diagram illustrating the operation and method of a system for safely operating heavy equipment in accordance with embodiments of the present specification

FIG. 9 is a flow diagram illustrating a system check and initialization procedure of a safety system for safely operating heavy equipment in accordance with embodiments of the present specification.

FIG. 10 is a flow diagram illustrating an active mode sensing procedure of a safety system for safely operating heavy equipment in accordance with embodiments of the present specification.

### DETAILED DESCRIPTION OF EMBODIMENTS

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

Embodiments described herein can provide passive and active safety devices, systems, and methods that can, among other features, visually alert bystanders (e.g., workers, pedestrians) to an equipment's zone of danger, thus discouraging bystanders from walking near or within a zone of danger and/or prohibiting bystanders from entering into dangerous proximity with the equipment.

Embodiments may further physically alert bystanders who enter a zone of danger by providing a flexible tentacle or wand that may come into physical contact with the bystander, thus notifying the bystander of impending danger.

Embodiments may further provide equipment operators with a visual indicator of clearance space at a side or rear of the equipment.

Embodiments may further provide visual and/or audible warnings to the equipment operator, and/or disable or otherwise affect the functionality of the equipment in response to sensing of bystanders or objects near or within a zone of danger.

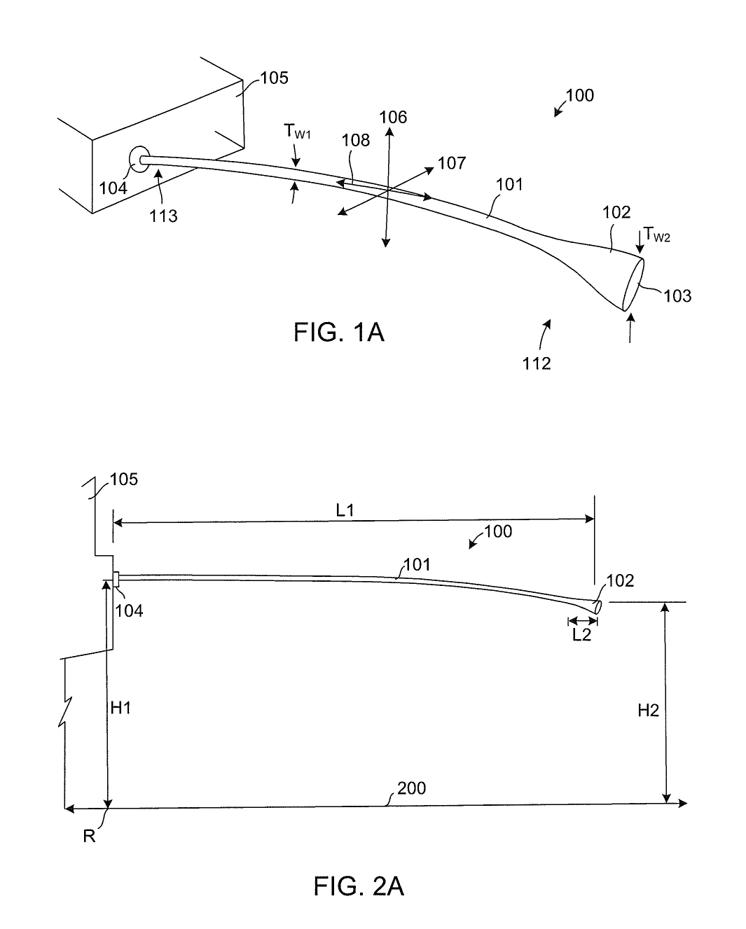

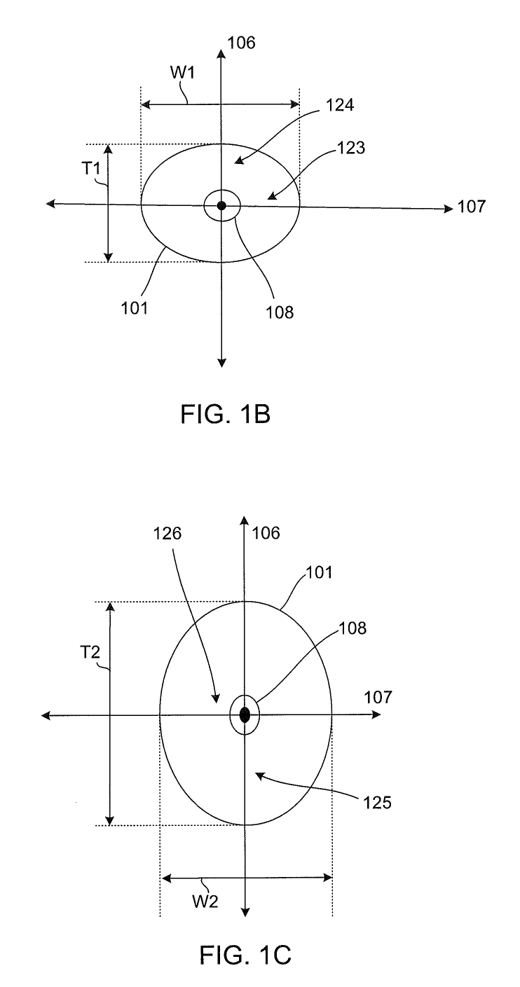

FIG. 1A is a three-dimensional perspective view of a safety device in accordance with embodiments of the present specification. A safety device 100 may comprise a tentacle or wand 101 having an enlarged impact head 102. The enlarged impact head 102 may be constructed and arranged to physically alert a bystander who comes in contact with the wand 101 without injuring or otherwise permanently harming the bystander.

The impact head 102 can be cone-shaped, spherically shaped or cylindrically shaped, and may further comprise an opening 103. The impact head 102 can be hallowed or solid, and may further comprise rubber, plastic, foam, synthetic cotton, and the like. The impact head 102 may be integral with wand 101; however, in other embodiments the impact head may be coupled to or secured to the wand 101. The impact head may be removably coupled to or secured to the wand 101 such that the safety device system may be configured with a variety of impact heads 102.

The wand 101 or a plurality thereof may be attached to front, side or rear faces of heavy equipment 105. In some embodiments, the wand 101 is cylindrical in shape; however the wand 101 is not limited thereto. For example, the wand 101 may include a circular rod or other type of longitudinally extending member.

The wand 101 can have a thickness T_{W1}, which ranges, in some embodiments, between about ¼ inches to about 4 inches. In other embodiments the thickness T_{W1} of the wand 101 can be less than ½ inches or greater than 4 inches. The enlarged impact head 102 can have a thickness T_{W2}, which ranges, in some embodiments, between about 3 inches to about 10 inches. In other embodiments the thickness T_{W2} of enlarged impact head 102 can be less than 3 inches or greater than 10 inches. The thickness T_{W2} may be greater than the thickness T_{W1}. In some embodiments, the thickness T_{W2} of the enlarged impact head 102 is greater than or equal to the largest cross-sectional length of an adult human eye socket.

The wand 101 can comprise spring steel, a durable plastic material, such as truck bed-liner material, PVC and the like, or a combination thereof. The wand 101 may comprise fiberglass poles, graphite poles, or spring steel. In some embodiments, the wand 101 is flexible in vertical 106 and horizontal 107 directions with respect to a lengthwise direction of extension 108 of the wand 101. In some embodiments, the wand 101 is flexible in vertical 106 and horizontal 107 directions with respect to an attachment mechanism 104, which may be fixedly attached to a piece of heavy equipment 105. The wand 101 may be flexible in the lengthwise direction of extension 108 of the wand 101. For example, the wand 101 may be compressed in the lengthwise direction of extension 108 of the wand 101.

The wand 101 can be attached to heavy equipment 105 via an attachment mechanism 104. The attachment mechanism 104 can comprise a male/female connector, a quick release connector, a pressure fit socket, a breakaway connector or combination thereof. In some embodiments, the breakaway connector allows for the wand 101 to be detached from heavy equipment 105 at or above a predetermined amount of pressure, for example, at about 10 pounds of pressure. In this manner, the wand 101 can separate from the attachment mechanism 104 without damaging or otherwise breaking the attachment mechanism 104 and/or the wand 101. Further, should a bystander get caught by the wand 101, the breakaway connector may prevent injury to the bystander.

The wand 101 may further comprise a reflector, glow-in-the-dark material, or other lighting source to illuminate the wand 101 and/or impact head 102 in low-light conditions. The reflector, glow-in-the-dark material, or other lighting source may be provided about an outer surface of the wand 101. The lighting source can comprise, but is not limited to, incandescent lamps, electroluminescent lamps, such as light emitting diodes, and gas discharge lamps, such as compact fluorescent lamps. In addition, the wand 101 can be painted with bright reflective materials. In some embodiments, glow sticks can be attached to or provided within the wand 101 to provide illumination.

In some embodiments, the wand 101 is attached to side or rear faces of heavy equipment 105 to provide visual and physical alerts to bystanders near or within an equipment's zone of danger. The visual alert provides visual notification to bystanders in proximity with the equipment, thus warning bystanders of the equipment's zone of danger. The physical alert provides physical notification to bystanders within the equipment's zone of danger. In some embodiments, the physical alert is provided when the wand 101 comes into physical contact with the bystander, thus notifying the bystander of impending danger.

FIG. 1B is a cross-sectional view of a wand of a safety device in accordance with embodiments of the present specification. FIG. 1B illustrates a cross-sectional view of an elliptical-shaped wand 101. In this example, a major-axis 123 of the elliptical-shaped wand 101 extends in the horizontal direction 107 and a minor-axis 124 of the elliptical-shaped wand 101 extends in the vertical direction 106. The elliptical-shaped wand 101 has a width W1 along the major-axis 123 and a thickness T1 along the minor-axis 124. In this example embodiment, the width W1 of the elliptical-shaped wand 101 is greater than the thickness T1 of the elliptical-shaped wand 101. In this manner, the flexibility of the wand is controlled to varying degrees in the vertical 106 and horizontal 107 directions with respect to a lengthwise direction of extension 108 of the wand 101. For example, the wand 101 may have an increased flexibility in the vertical direction 106 with respect to the flexibility of the wand 101 in the horizontal direction 107. The wand 101 may have a decreased flexibility in the horizontal direction 107 with respect to the flexibility of the wand 101 in the vertical direction 106.

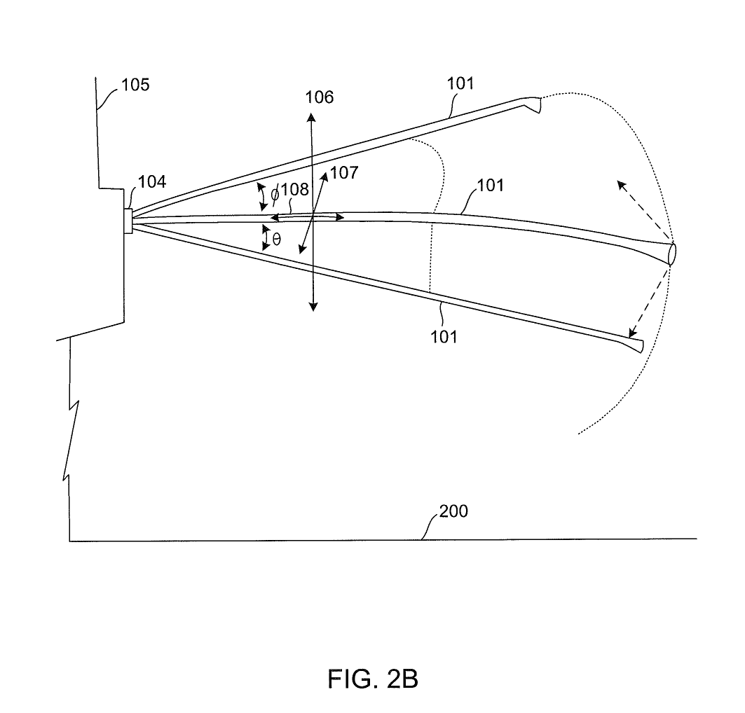

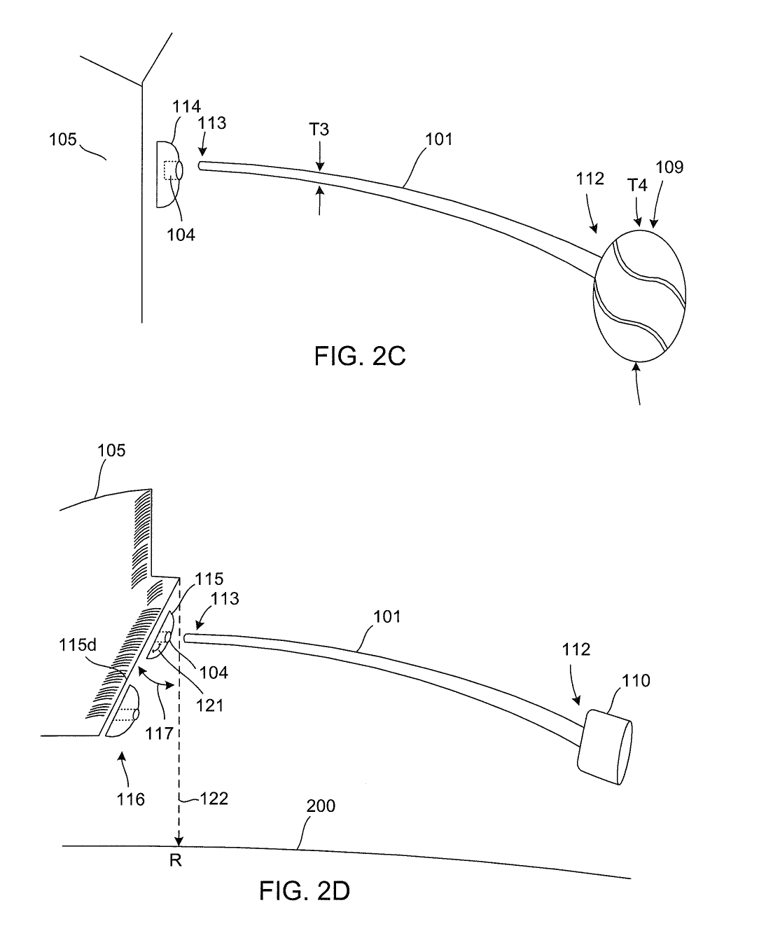

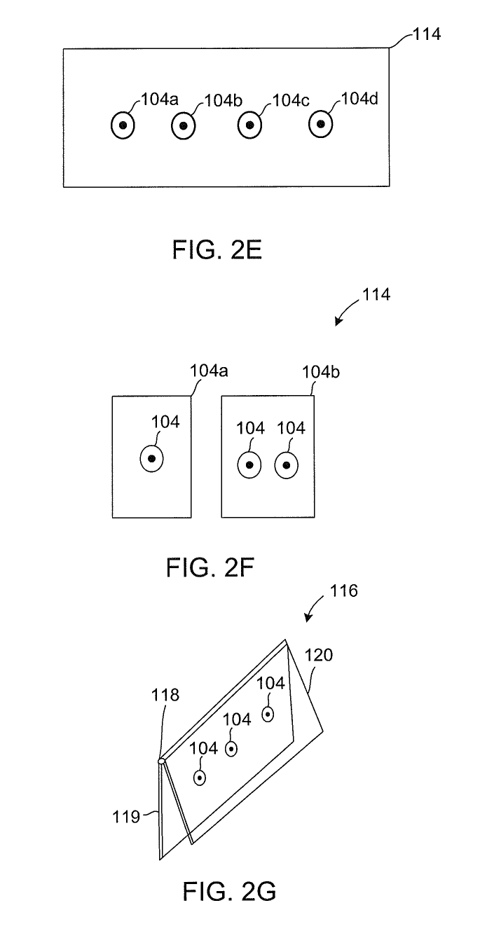

Referring to FIG. 2B, the wand 101 as illustrated with respect to FIG. 1B can be flexible in the vertical direction 106 by θ degrees and in the horizontal direction 107 by φ degrees with respect to the lengthwise direction of extension 108 of the wand 101. In the example embodiment of FIG. 1B, θ can range between 0 degrees and about ±25 degrees in both the upward and downward vertical directions 106, and φcan range between 0 degrees and ±20 degrees in the horizontal direction 107 with respect to the wand's 101 stationary rest position. In another example embodiment, the absolute value of 0 is greater than the absolute value of φ.

FIG. 1C is a cross-sectional view of a wand of a safety device in accordance with another embodiment of the present specification. FIG. 1C illustrates a cross-sectional view of an elliptical-shaped wand 101. In this example, a minor-axis 126 of the elliptical-shaped wand 101 extends in the horizontal direction 107 and a major-axis 125 of the elliptical-shaped wand 101 extends in the vertical direction 106. The elliptical-shaped wand 101 has a width W2 along the minor-axis 126 and a thickness T2 along the major-axis 125. In this example embodiment, the thickness T2 of the elliptical-shaped wand 101 is greater than the width W2 of the elliptical-shaped wand 101. In this manner, the flexibility of the wand is controlled to varying degrees in the vertical 106 and horizontal 107 directions with respect to a lengthwise direction of extension 108 of the wand 101. For example, the wand 101 may have an increased flexibility in the horizontal direction 107 with respect to the flexibility of the wand 101 in the vertical direction 106. The wand 101 may have a decreased flexibility in the vertical direction 106 with respect to the flexibility of the wand 101 in the horizontal direction 107.

Referring to FIG. 2B, the wand 101 as illustrated with respect to FIG. 1C can be flexible in the vertical direction 106 by θ degrees and in the horizontal direction 107 by φ degrees with respect to the lengthwise direction of extension 108 of the wand 128. In the example embodiment of FIG. 1C, θ can range between 0 degrees and about ±20 degrees in both the upward and downward vertical directions 106, and φ can range between 0 degrees and ±25 degrees in the horizontal direction 107 with respect to the wand's 101 stationary rest position. In another example embodiment, the absolute value of φ is greater than the absolute value of θ.

FIG. 2A is a side view of a safety device attached to equipment in accordance with embodiments of the present specification. The wand 101 is shown attached to a piece of heavy equipment 105 via an attachment mechanism 104. The wand 101 has a length L1, which ranges, in some embodiments, between about 2 feet to about 10 feet in length. In other embodiments the length L1 of the wand can be less than 2 feet or greater than 10 feet in length. In some embodiments, the length L1 of the wand 101 can be cut to a length that is suitable or appropriate for certain applications. The impact head 102 has a length L2, which ranges, in some embodiments, between about 2 inches to about 1 foot in length.

The attachment mechanism 104 can be secured to heavy equipment 105 by glue, epoxy, fasteners, such as, screws, rivets, and bolts, or by welding the attachment mechanism 104 to the heavy equipment 105. The heavy equipment 105 may be manufactured to include one or more attachment mechanisms 104. However, one or more attachment mechanisms 104 may be attached to a piece of heavy equipment 105 in a post-manufactured state. That is, one or more attachment mechanisms 104 may be attached to a piece of heavy equipment 105 during an aftermarket installation procedure.

The attachment mechanism 104 is secured to heavy equipment 105 at a height H1, relative to a reference point R, such as a ground point 200, and the wand 101 can be attached to equipment 105 via the attachment mechanism 104. Due to the flexibility of the wand 101 or the angle at which the wand 101 is attached to the heavy equipment 105 by the attachment mechanism 104, in some embodiments, the height H2 of the impact head 102 is less than the height H1 of the of the attachment mechanism 104 as measured from the reference point R, such as the ground point 200.

FIG. 2B is a side view of a safety device attached to equipment in accordance with embodiments of the present specification. The wand 101 can be flexible in the vertical direction 106 by θ degrees and in the horizontal direction 107 by φ degrees with respect to the lengthwise direction of extension of the wand 101. In one embodiment, θ can range between 0 degrees and about ±25 degrees in both the upward and downward vertical directions 106, and φ can range between 0 degrees and ±25 degrees in the port and starboard horizontal directions 107 with respect to the wand's 101 stationary rest position.

FIG. 2C is a three-dimensional perspective view of a safety device in accordance with another embodiment of the present specification. The wand 101 may include a spherically shaped impact head 109 attached to a distal end 112 of the wand 101. The spherically shaped impact head 109 may include a tennis ball, a rubber ball, a racket ball or a balloon. A proximal end 113 of the wand 101 can be configured to engage an attachment mechanism 104, and a base 114 of the attachment mechanism 104 may be coupled to a piece of heavy equipment 105.

The wand 101 can have a thickness T3, which ranges, in some embodiments, between about ½ inches to about 4 inches. In other embodiments the thickness T3 of the wand can be less than ½ inches or greater than 4 inches. In some embodiments, the wand 101 is tapered. For example, in some embodiments a thickness of the wand 101 may become smaller in a direction extending from the proximal end 113 to the distal end 112; however, in other embodiments a thickness of the wand 101 may become larger in a direction extending from the proximal end 113 to the distal end 112.

The spherically shaped impact head 109 can have a thickness T4, which ranges, in some embodiments, between about 3 inches to about 10 inches. In other embodiments the thickness T4 can be less than 3 inches or greater than 10 inches. In one embodiment, the thickness T4 is greater than or equal to the largest cross-sectional length of an adult human eye socket.

FIG. 2D is a three-dimensional perspective view of a safety device in accordance with another embodiment of the present specification. The wand 101 can include a foam head 110 attached to a distal end 112 of the wand 101. A proximal end 113 of the wand 101 can be configured to engage an attachment mechanism 104, and a base 115, 116 of the attachment mechanism 104 may be coupled to a piece of heavy equipment 105.

The base 115, 116 can be attached to, for example, a downward facing portion 105d of a piece of heavy equipment 105. In one embodiment, the base 116 can comprise an articulating member so that the proximal end 113 of the wand 100 is substantially planar relative to a surface of the ground point 200 when the wand 101 is attached to the downward facing portion 105d of the heavy equipment 105.

FIG. 2E is a front view of a base in accordance with embodiments of the present specification. A base 114 can comprise a plurality of attachment mechanisms 104a, 104b, 104c, 104d. In one embodiment, the attachment mechanisms are angled so that the resting position of attached wands 101 can be adjusted in at least the vertical 106 or horizontal 107 directions.

FIG. 2F is a front view of a base in accordance with another embodiment of the present specification. A base 114 may comprise a plurality of sub-bases 114a, 114b. Each of the plurality of sub-bases 114a, 114b may include one or more attachment mechanisms 104.

FIG. 2G is a side view of an articulating base in accordance with embodiments of the present specification. An articulating base 116 comprises a rear base portion 119 and a front base portion 120. The rear base portion 119 and front base portion 120 are attached via an articulation mechanism 118, such as a hinge or pivot. A plurality of attachment mechanisms 104 can be secured to the front base portion 120 and the rear base portion 119 can be attached to a surface of a piece of heavy equipment 105.

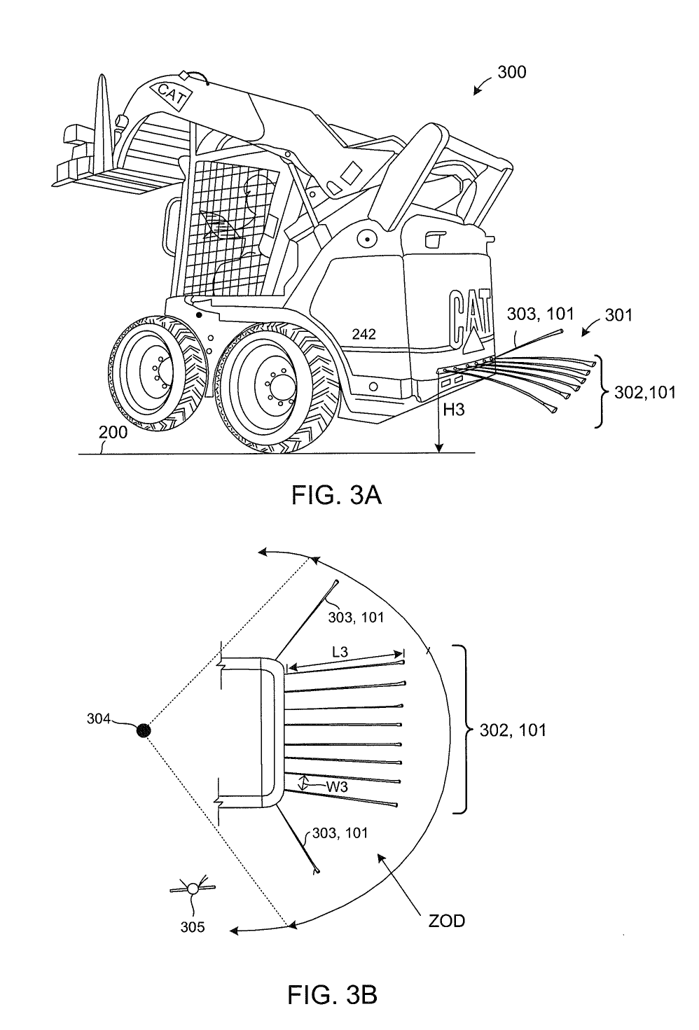

FIG. 3A is a side and rear perspective view of a skid steer having a safety device attached thereto in accordance with embodiments of the present specification. In this embodiment, a safety device 301 comprises a plurality of rearward extending wands 302, 101, and optional side wands 303, 101. The wands 302, 303, 101 are attached to a skid steer 300 at a height H3 from a ground point 200, which ranges, in some embodiments, between about 1 feet to about 4 feet in height. The wands 302, 303, 101 may be attached to the skid steer 300 at a height H3 less than an average height of a bystander's head region so as to reduce the chances that the wand 101 may come into contact with a bystanders head, thus reducing or preventing head injuries.

FIG. 3B is a top view of the skid steer shown in FIG. 3A in accordance with embodiments of the present specification. The plurality of rearward extending wands 302, 101 have a length L3, and are spaced apart from each other by a width W3. In one embodiment, the width W3 is about 6 inches to about 2 feet in width, and the length L3 is about 2 feet to about 5 feet in length. In some embodiments, which comprise optional side wands 303, 101, the length of the optional side wands 303, 101 can be equal to or less than the length L3 of the plurality of rearward extending wands 302, 101.

FIG. 3B further illustrates that the safety device 301 can provide a visual alert to an operator or bystander 305 present within or near the equipment's zone of danger ZOD where possible injury to an operator or bystander can occur. Further, the plurality of wands 302, 303, 101 of the safety device 301 can come into physical contact with the bystander 305 present within the equipment's zone of danger ZOD, thus notifying the bystander 305 of impending danger.

In one embodiment, the zone of danger ZOD is defined by the position and/or movement of the plurality of rearward extending wands 302, 101 and/or optional side wands 303, 101 attached to the skid steer 300. For example, when the skid steer 300 rotates about its axis 304, the plurality of rearward extending wands 302, 101 and optional side wands 303, 101 also rotate about the axis 304, providing a visual indication of the equipment's zone of danger ZOD. The zone of danger can be defined by the distal end of the wand 101 and/or an impact head 102 provided at the distal end of the wand 101.

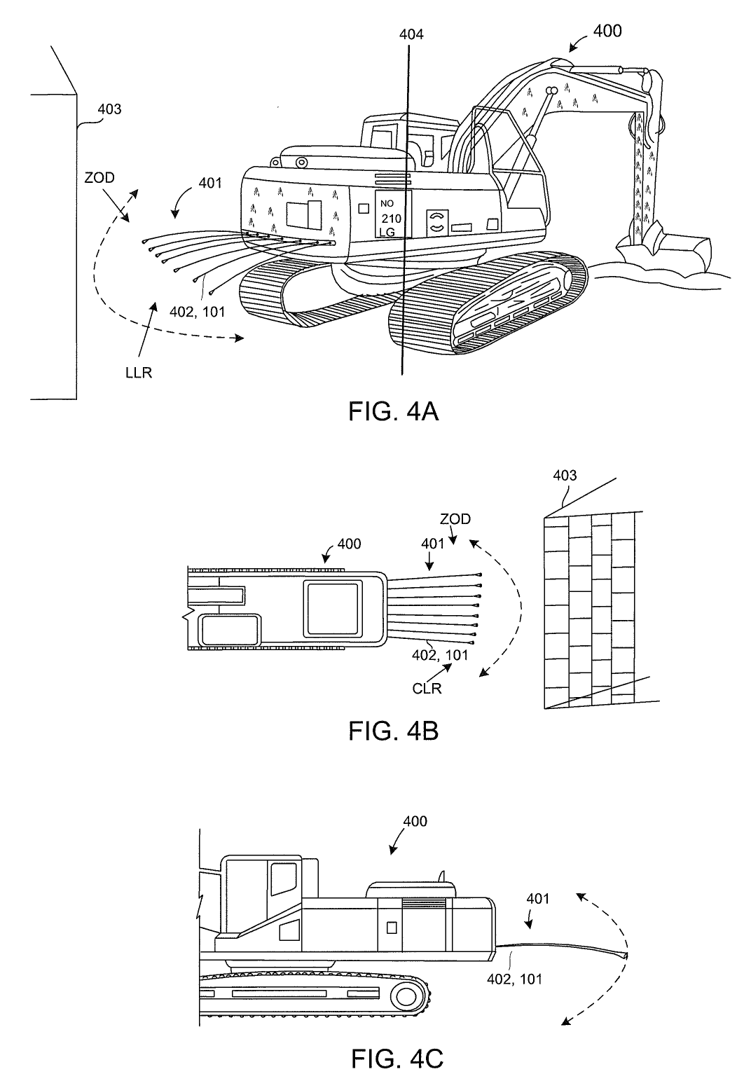

FIG. 4A is a side and rear perspective view of an excavator having a safety device attached thereto in accordance with embodiments of the present specification; FIG. 4B is a top view of the excavator shown in FIG. 4A in accordance with embodiments of the present specification; and FIG. 4C is a side view of the excavator shown in FIG. 4A in accordance with embodiments of the present specification. Attached to a rear portion of an excavator 400 is a safety device 401 which comprises at least one wand 402, 101. In this embodiment, the safety device 401 comprises a plurality of wands 402, 101. In other embodiments, the safety device 401 can be attached to side portions of the excavator in the manner shown above in connection with FIGS. 3A and 3B.

The safety device 401 can provide an equipment operator with a visual indicator of clearance space CLR at rear and side regions of the equipment 400. In one embodiment, the clearance space CLR is defined as the distance between a distal or outermost portion of the equipment relative to the equipment's axis 404 of rotation and another object, such as a building 403, bystander or other piece of equipment. In another embodiment, the clearance space CLR is defined as the distance between the outermost ends of the wands 402, 101 and other objects, such as a building 403, bystander or other piece of equipment.

For example, when the excavator 400 rotates about its axis 404, the wands 402 may also rotate about the axis 404, thus providing the equipment operator with a visual indicator of clearance space CLR. In one embodiment, the wands 402, 101 of the safety device 401 can be constructed of a flexible material so as not to cause significant damage to nearby buildings or equipment that may by contacted by the wands 402, 101 during operation of the equipment 400. The wands 402, 101 can also be constructed so as not to cause serious injury to nearby bystanders who may be contacted by the wands 402, 101 during operation of the equipment 400.

During operation, the safety device 401 can also provide a visual alert to bystanders of an equipment's zone of danger ZOD.

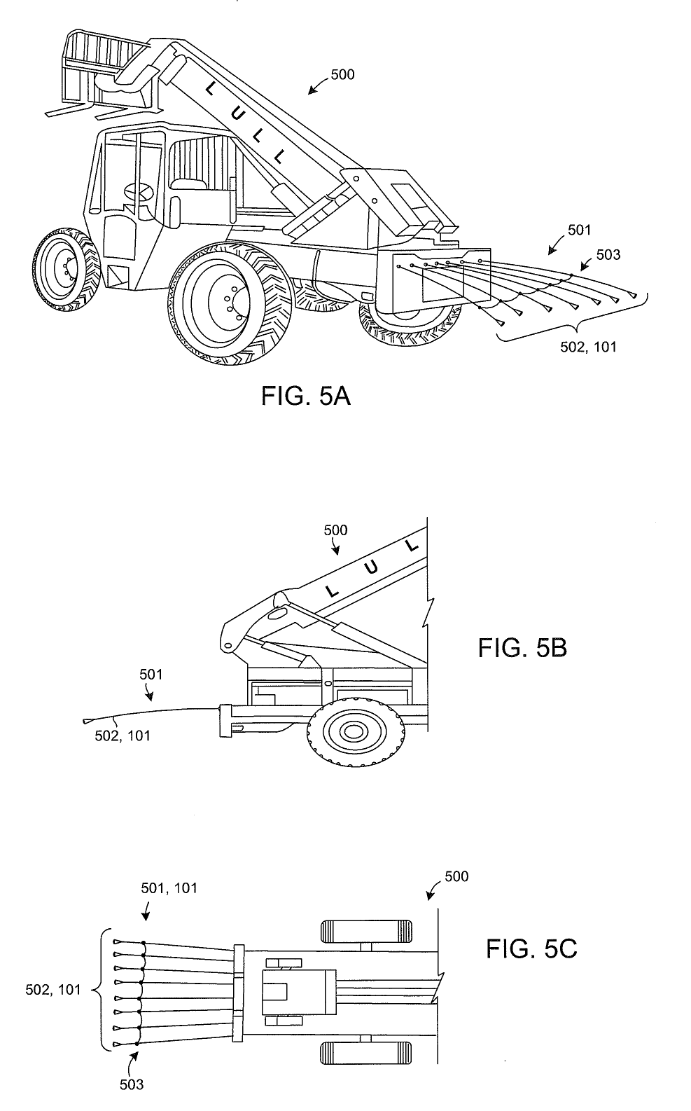

FIG. 5A is a side and rear perspective view of a telehandler having a safety device attached thereto in accordance with embodiments of the present specification; FIG. 5B is a side view of the telehandler shown in FIG. 5A in accordance with embodiments of the present specification; and FIG. 5C is a top view of the telehandler shown in FIG. 5A in accordance with embodiments of the present specification. Attached to a rear member of the telehandler 500 is a safety device 501 which comprises a plurality of wands 502, 101.

The wands 502, 101 of the safety device 501 can be optionally bridled to one another. The bridle 503 can comprise rope, chain, bungee cord, elastic material and the like.

Although the example embodiments shown above demonstrate that the safety devices can be applied to rear and side portions of heavy equipment, the safety devices and systems can also be applied to other portions of heavy equipment, such as front, top and bottom portions of the heavy equipment, where operator visibility can be poor, depending on the type and size of the heavy equipment.

The example embodiments shown above are related to passive devices, systems and methods, in that they provide visual and/or tactile feedback to an operator or bystander. In addition to the passive safety devices, systems and methods described herein, active safety devices, systems and methods can be incorporated into the safety devices, systems and methods to further provide further visual and/or audible warnings to an equipment operator, bystander, work site supervisor and/or off-site safety technician in response to sensing of workers, pedestrians and/or other objects detected near or within an equipment's zone of danger. Further, the active safety devices, systems and methods can provide for disabling and/or otherwise affecting the functionality of the equipment having detected objects near or within its zone of danger, thus preventing serious injury or damage to nearby bystanders and objects.

Active safety devices, systems and methods can further provide an override mechanism, which allows the equipment operator, work site supervisor and/or off-site safety technician to override any disabling and/or functionality adjustments to the equipment having detected objects near or within its zone of danger. In addition, active safety devices, systems and methods can provide a remote enabling mechanism that allows a bystander, work site supervisor and/or off-site safety technician a means for remotely enabling a response avoidance procedure.

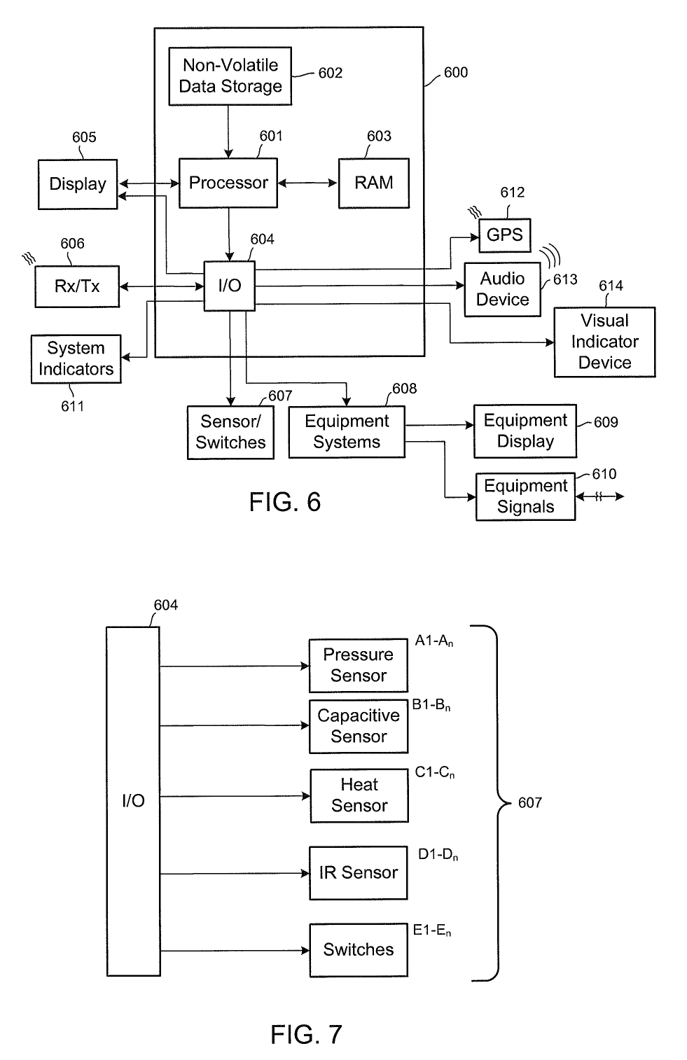

FIG. 6 is a block diagram of a safety device system in accordance with embodiments of the present specification. A safety device system 600 may comprise a processor 601 (e.g., central processing unit (CPU), microprocessor (μP), digital signal processor (DSP), programmable logic device (PLD), ext . . . ), non-volatile data storage 602, random access memory (RAM) 603 and an input/output (I/O) device 604. In some embodiments, the processor 601 comprises the non-volatile data storage 602, the random access memory (RAM) 603, the I/O device 604 or a combination thereof.

A display device 605 (e.g., CRT, LED, LCD, TFT, OLDE, Plasma) is optionally connected to the safety device system 600 via the processor 601 or the I/O device 604. The display device 605 can present system information, such as, system status (e.g., on/off, activated, initialized, faults, object detection, avoidance enabled) and/or modes of operation to the equipment operator. The display device can comprise a touch-interface, which allows a user to interact with and/or input information into the safety device system 600.

Sensors and switches 607 can be connected to the safety device system 600 via the I/O device 604. The sensors and switches 607 can be attached to or integrated with the safety devices 100, 301, 401, 501 to detect bystanders and/or other objects near or within a zone of danger ZOD. In one embodiment, the sensors are integrated with wands 101, 302, 303, 402, 502 of the safety devices 100, 301, 401, 501.

In one embodiment, the sensors and switchers 607 are wirelessly connected to the safety device system 600.

The safety device system 600 is optionally connected to the equipment systems 608 so that the safety device system 600 can activate a response avoidance procedure, which can disable and/or otherwise affect the functionality of heavy equipment upon the detection of bystanders or objects near or within an equipment's zone of danger. Such a procedure may require the safety device system 600 to communicate with and/or control the equipments systems 608 and signals 610. The safety device system 600 can further communicate with the equipment systems 608 to display safety system information, such as, system status and/or modes of operation on the equipment display 609, dashboard or gauges.

The safety device system 600 can further comprise a receiver/transmitter 606 that is connected to the processor 601 or the I/O device 604. The receiver/transmitter 606 allows for a bystander, work site supervisor and/or off-site safety technician to remotely activate a response avoidance procedure or override the activation of a response avoidance procedure. In one embodiment, a response avoidance procedure can only be overridden by a bystander, work site supervisor and/or off-site safety technician. That is, the equipment operator cannot override the response avoidance procedure. In other embodiments, the equipment operator can override an activated response avoidance procedure. The receiver/transmitter 606 can operate, for example, according to the frequency ranges listed in Table 1 below.

TABLE 1
Receiver/Transmitter Frequency Ranges

| Frequency | | Implementations |
|---|---|---|
| 30-300 | kHz | lowFER devices |
| 300-3000 | kHz | AM broadcasting devices |
| 3-30 | MHz | Shortwave devices |
| 30-300 | MHz | FM broadcasting devices |
| 300-3000 | MHz | mobile telephony devices, cordless telephony |
| | | devices, wireless networking devices, remote |
| | | keyless entry devices, GPR devices |
| 3-30 | GHz | Wireless networking devices, satellite link |
| | | devices, microwave link devices |
| 30-300 | GHz | Microwave data link devices |

The safety device system 600 can further comprise system indicators 611 that are connected to the processor 601 or the I/O device 604. The system indicators 611 present system information, such as, system status and/or modes of operation to an equipment operator. The system indicators 611 can comprise: LEDs, incandescent lights, gauges, meters, buzzers, and horns. In one embodiment, the system indicators 611 can be mounted within an equipment operator cabin, such that the operator can readily view the system indicators 611 while operating the equipment.

The safety device system 600 can further comprise a GPS device 612 that is connected to the processor 601 or the I/O device 604. The GPS device 612 can provide the safety device system 600 with absolute location, relative movement, and time parameters. Such information can be logged and stored in the non-volatile data storage 602 of the system. The safety device system 600 can record the GPS parameters (e.g., absolute location, relative movement, and time) and/or other system information parameters (e.g., system status, object detection, avoidance procedure activated, override activated) during equipment operation. The recorded parameters can later be recovered and used for accident investigation, as well as for analyzing worksite safety issues and performance.

The safety device system 600 can further comprise audio 613 and visual 614 devices that can provide audible and visual warnings to an equipment operator, bystander, work site supervisor and/or off-site safety technician in response to sensing of workers, pedestrians and/or other objects detected within a zone of danger. The audio device 613 can comprise, for example, a buzzer, a horn, a speaker or a bell. The visual device can comprise, for example, a strobe light, LEDs or other lighting device. In one embodiment, upon the detection of bystanders or objects near or within the equipment's zone of danger, a response avoidance procedure can visually or audibly notify a bystander of impending danger and/or disable or reduce the functionality of heavy equipment.

FIG. 7 is a block diagram of an I/O subsystem having sensors connected thereto in accordance with embodiments of the present specification. A plurality of sensors and switches can be connected to the processor 601 or the I/O subsystem 604. Pressure sensors A1-An, capacitive sensors B1-Bn, heat sensors C1-Cn, IR sensors D1-Dn, switches (e.g., pushbutton, toggle, momentary) E1-En, or a combination thereof can be attached to or integrated with safety devices 100, 301, 401, 501 to detect bystanders and/or other objects within a zone of danger ZOD.

The methods disclosed herein can be implemented by the safety device system of FIGS. 6 and 7, or equivalent systems, executing a unique set of instructions stored in system memory. As will be appreciated by those skilled in the art, a unique set of instructions can be implemented or embodied in software, firmware, or a combination thereof.

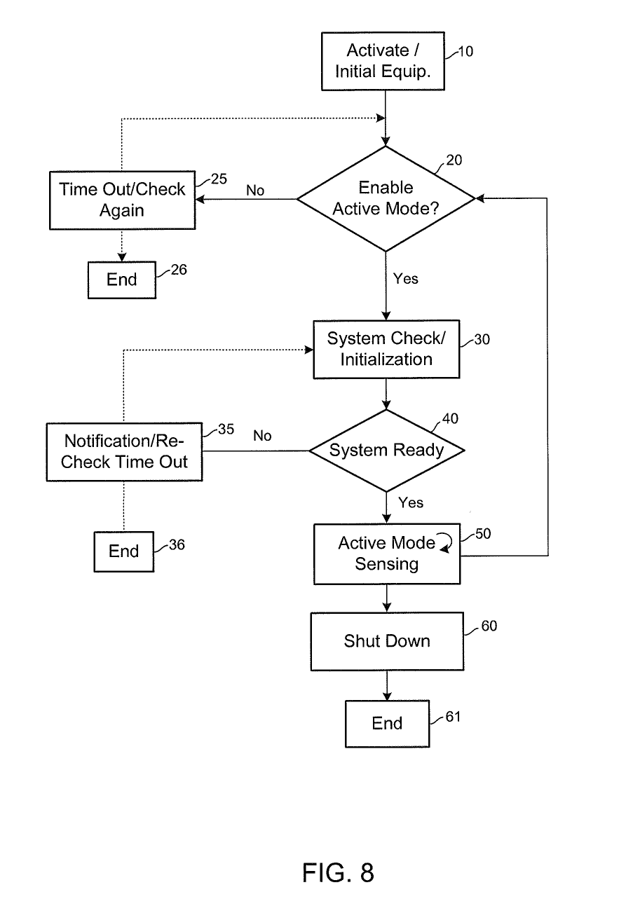

FIG. 8 is a flow diagram illustrating the operation and method of a system for safely operating heavy equipment in accordance with embodiments of the present specification. A safety device system is powered on and preliminary initialized to execute a unique set of instructions 10. In one embodiment, the unique set of instructions correspond to the operation and method disclosed in FIG. 8.

The system determines if an active mode is enabled 20. If the active mode is disabled, the safety system can continue to check if an active mode is later enabled 20, 25 (“check and wait mode”) or the safety system can timeout and end 25, 26. If the active mode is enabled, the safety system runs a system check and initialization routine 30. At the completion of the system check and initiation routine 30, the safety system determines if the system is ready to operate in the active mode 40. If the safety system is not ready to operate in the active mode, the system can provide a notification via the system display 605, system indicators 611 and/or the equipment's display 609, 35. In addition, the system can re-run the system check and initialization procedure 30 or timeout and end 35, 36. In one embodiment, the safety system will disable the operation or limit the operation of equipment in response to the system not being ready to operate in the active mode, i.e., “lock-out feature”. If the safety system is ready to operate in the active mode, the safety system runs an active mode sensing procedure 50.

While the safety system is engaged in active mode sensing 50, a response avoidance procedure can be activated 53. If the active mode sensing procedure 50 is subsequently disabled, the safety system can re-enter a check and wait mode 20 or the system can shut down and end 60, 61.

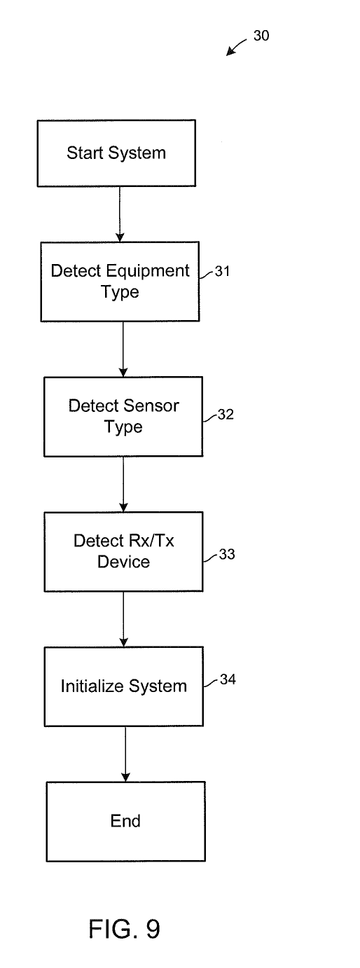

FIG. 9 is a flow diagram illustrating a system check and initialization procedure of a safety system for safely operating heavy equipment in accordance with embodiments of the present specification. The safety system detects the type of heavy equipment having the system installed thereon 31. The safety system detects the type or types of sensors connected to the safety system 32. The safety system detects whether a receiver/transceiver device is connected to the system 33, and further tests a communication link between the receiver/transceiver device and a remote communication device. The safety system is initialized for operation based on the detected equipment type, sensor type, and receiver/transceiver communication link.

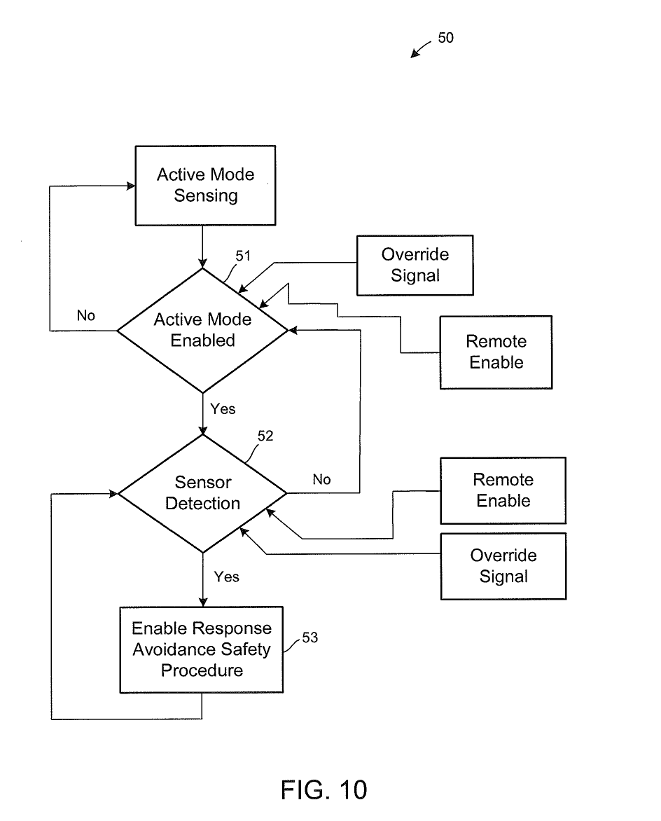

FIG. 10 is a flow diagram illustrating an active mode sensing procedure of a safety system for safely operating heavy equipment in accordance with embodiments of the present specification. The safety system determines if an active mode is enabled 51. If the active mode is disabled, the safety system continues to check for enablement of active mode sensing 51. If the active mode is enabled, the safety system enters a sensor detection procedure 52. The safety system continuously determines whether a sensor or switch of the safety system has detected a bystander or object near or within an equipment's zone of danger 52, and if a bystander or object is detected by the safety system, a response avoidance safety procedure is enabled 53. The response avoidance safety procedure 53 may include a disabling of the heavy equipment, such as disabling movement of the heavy equipment. The response avoidance safety procedure 53 may slow or otherwise reduce movements or actions of the heavy equipment.

Further, in one embodiment, an operator can override the enablement of the active mode and/or override the sensor detection procedures. In another embodiment, the receiver/transmitter 606 allows for a bystander, work site supervisor and/or off-site safety technician to remotely activate/enable the active mode and the sensor detection procedure.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A safety device, comprising:
an elongated wand having an enlarged impact head,
wherein the elongated wand is flexible in vertical and horizontal directions with respect to a lengthwise direction of extension of the elongated wand.

2. The device of claim 1, wherein the enlarged impact head is provided at a distal end of the elongated wand.

3. The device of claim 2, wherein a thickness of the enlarged impact head is greater than a thickness of a proximal end of the elongated wand.

4. The device of claim 1, wherein a thickness of the enlarged impact head is greater than a thickness of a central portion of the elongated wand.

5. The device of claim 1, wherein the enlarged impact head is integral with the elongated wand.

6. The device of claim 1, wherein the elongated wand is tapered.

7. The device of claim 1, wherein the enlarged impact head is coupled to a distal end of the elongated wand.

8. The device of claim 7, wherein the enlarged impact head is removably coupled to the distal end of the elongated wand.

9. The device of claim 1, wherein a cross-section of the elongated wand in a direction perpendicular to the lengthwise direction of extension is circular.

10. The device of claim 1, wherein a cross-section of the elongated wand in a direction perpendicular to the lengthwise direction of extension is elliptical.

11. The device of claim 1, wherein a cross-section of the elongated wand in a direction perpendicular to the lengthwise direction of extension is rectangular.

12. The device of claim 1, wherein the elongated wand has an increased flexibility in the vertical direction with respect to a flexibility of the elongated wand in the horizontal direction.

13. The device of claim 1, wherein the elongated wand has an increased flexibility in the horizontal direction with respect to a flexibility of the elongated wand in the vertical direction.

14. The device of claim 1, wherein the elongated wand is flexible in the lengthwise direction of extension.

15. The device of claim 1 further comprising an attachment mechanism, wherein the attachment mechanism is constructed and arranged to secure the elongated wand to a piece of heavy equipment.

16. The device of claim 15, wherein the attachment mechanism is selected from the group consisting of: a male connector, a female connector, a pressure fit socket, a breakaway connector and a bracket.

17. The device of claim 15, wherein the attachment mechanism is constructed and arranged to allow the elongated wand to separate from the attachment mechanism at or above a predetermined amount of pressure.

18. The device of claim 1, wherein the elongated wand is at least 3 feet in length.

19. The device of claim 1, wherein the enlarged impact head includes a material selected from the group consisting of: rubber, plastic and foam.

20. The device of claim 1, wherein the elongated wand includes a material selected from the group consisting of: plastic, fiberglass, graphite and steel.

21. The device of claim 1, wherein the elongated wand is constructed and arranged to flex at least ±20 degrees in the vertical direction.

22. The device of claim 1, wherein the elongated wand is constructed and arranged to flex at least ±20 degrees in the horizontal direction.

23.-40. (canceled)
